(19) United States
(12) Patent Application Publication
(10) Pub. No.: US 2012/0284790 A1
(43) Pub. Date: Nov. 8, 2012

(54) LIVE SERVICE ANOMALY DETECTION SYSTEM FOR PROVIDING CYBER PROTECTION FOR THE ELECTRIC GRID

(75) Inventor: Rajeev BHARGAVA, Ontario (CA)

(73) Assignee: Decision-Zone Inc., Ontario (CA)

(21) Appl. No.: 13/462,543

(22) Filed: May 2, 2012

Related U.S. Application Data
(63) Continuation-in-part of application No. 13/026,562, filed on Feb. 14, 2011.
Application No. 13/026,562 is a continuation of application No. 11/530,885, filed on Sep. 11, 2006, now Pat. No. 7,908,160.
(60) Provisional application No. 61/591,097, filed on Jan. 26, 2012.

(51) Int. Cl. G06F 21/00; G06F 11/30

(52) U.S. Cl. 726/22

(57) ABSTRACT

Provided is a method of improving security in an electrical grid network. The method includes configuring a lifecycle map associated with an operation in the electrical grid network, the lifecycle map including at least a start configuration, a final configuration, and a plurality of valid events arranged to link the start configuration and the final configuration, the start configuration and the final configuration corresponding to particular states of the electrical grid network. The method also includes monitoring at least one of messages and device configurations in the electrical grid network to detect one or more live events associated with the operation and comparing the plurality of live events to the lifecycle map to identify an anomaly in the live events.

### CROSS REFERENCE TO RELATED APPLICATIONS

This application claims the benefit of U.S. Provisional Application No. 61/591,097, filed on Jan. 26, 2012, and is a continuation-in-part of U.S. application Ser. No. 13/026,562, filed on Feb. 14, 2011. U.S. application Ser. No. 13/026,562 is a continuation of U.S. application Ser. No. 11/530,885 (now U.S. Pat. No. 7,908,1609), filed on Sep. 11, 2006. U.S. Provisional Application No. 61/591,097, U.S. application Ser. No. 13/026,562, and U.S. application Ser. No. 11/530,885 are hereby incorporated by reference in their entireties.

### BACKGROUND OF THE INVENTION

1. Field of the Invention

The present invention relates to cybersecurity for critical infrastructure. More particularly, the present invention relates to providing cyber protection tools for the communications and network infrastructure of the electrical grid.

2. Background

The United States' (U.S.) energy sector faces an increasingly sophisticated and aggressive threat environment. Intelligence reports indicate that cyber adversaries are more persistent and better financed. As such, their ability to develop and launch new attack tools and techniques could outpace the sector's ability to develop and deploy new countermeasures. Within the energy sector, the U.S. electrical grid remains critically vulnerable to actual physical attacks, particularly to cyber attacks.

The U.S. Department of Homeland Security has identified 17 sectors defined as critical infrastructure sectors. The sectors include, for example, agriculture and food, banking and finance, defense industrial base, water, transportation systems, energy, healthcare, critical manufacturing, etc. Although it can be argued that all of these critical infrastructure systems may additionally be vulnerable to cyber attacks, all of these other critical infrastructure sectors also depend upon energy and the electric grid. Therefore, continued operation of the electric grid, ensuring the delivery of electricity, is fundamental to the operation of all of the other critical infrastructure sectors.

The security of the electric grid has an additional significance given that the industry is demand driven. In the electric grid, electricity is generated as it is used with minimal storage capability. A business component of the demand driven nature of the electric grid is known as demand response (DR). Demand response is a rate structure designed to lower a customer's energy consumption in exchange for a utility provider's ability to moderate power during peak loading events. Unlike the other critical infrastructure sectors, electricity cannot be stored (at least, not in any large scale way). By contrast, although water security is critically important, water can be stored for use during an emergency. Agriculture and food security are also important. However, like water, food can also be stored.

Since electricity cannot be stored, it must be produced when it is demanded. The security of the electrical grid is paramount because electricity will only be available in sufficient quantity if it is produced such that supply meets or exceeds demand on an ongoing basis.

Numerous government officials have been credited with statements that indicate that a successful cyber attack against the U.S. electrical grid could be the new Pearl Harbor, or that cyber attacks against the electrical grid represent the battleground of the future. A successful cyber attack on our grid could have a devastating impact on U.S. national security, economic success, and the stability of the American way of life. Vulnerabilities to the grid are real and the long-term consequences of a successful wide-spread attack are so catastrophic as to be unimaginable.

It is surmised, for example, that a cyber-attack could be launched by a nation-state, terrorist organization, or unemployed hackers targeting smart meters to switch off a country's electricity supply. However, these are only examples of parties that might launch a cyber-attackers or part of the electric grid that might be a target, and many other potential related dangers exists.

Experts also warn consumers that the communications infrastructure of the electrical grid is becoming increasingly vulnerable to cyber-attack due to the increased integration and two-way communication featured in smart grids as compared to existing electrical grid systems. Before discussing such vulnerabilities more precisely, a general background discussion on the basic architecture of the U.S. electrical grid will be presented to help provide additional context about aspects of the U.S. electric grid that may be targets of cyber-attacks so as to understand how attacks may occur to illustrate how embodiments may help counter such attacks.

FIG. 1 is a block diagram illustration 100 of conventional systems included in the U.S. electric grid. In the U.S. electric grid, as is generally well understood, thousands of power generators, such as generating plant 102, convert primary energy sources including coal, nuclear power, natural gas, and renewable fuels (such as hydropower, biomass, wind, and solar) into electricity. Power generators include a wide range of generation capacities. Power is transmitted and managed by a group of transmission substations 104 across a power transmission network including, for example, transmission lines (not shown) and other transmission infrastructure. Distribution stations 106 distribute the power to users, such as residents 108, commercial establishments 110, and industrial consumers 112.

Control centers 114, via public networks 116, manage the operation of generating plant 102, transmission substations 104, and distribution substations 106, along with cooling, waste heat recovery, and emission control systems (not shown). The control centers 114 monitor and control, for example, transformer operation and electricity flow through hundreds of thousands of miles of transmission lines.

Control systems, such as those included in control center 114, that manage national (e.g., critical) infrastructure devices are referred to as industrial control systems (ICS). ICS are not only used in the electric grid. ICS are also fundamental to the manufacturing industry as components in distributed automation (DA) systems.

At a high level, ICS are merely information technology (IT) systems designed to manage devices used in critical infrastructure systems. ICS can be broadly classified as covering three major subsystems: Supervisory control and data acquisition (SCADA), distributed control systems (DCS), and programmable logic controllers (PLCs). Regardless of the specific type of ICS, ICS devices generally provide real-time status/control for network devices, monitor alerts and alarms, as well as many other critically important services. ICS devices also typically include interface components, communications components, remote control capability, as well as input/output sensors. Since many of these ICS components are networked with commercial operating systems, the Internet, and may be configured for wireless communication, they include inherent cyber-security vulnerabilities.

FIG. 2A is a block diagram illustrating an example SCADA communication architecture 200 used in conjunction with the control center 114 of electrical grid architecture 100 of FIG. 1. As background, SCADA systems are used to monitor and control dispersed operations and energy management systems (EMS) used in the electrical grid architecture 100. Communication architecture 200 includes a SCADA network 202 used to control and optimize electricity flow to, and within, commercial establishment 110, via corporate local area network (LAN) 204. Many utility companies are replacing their existing meters with new smart meters 208, also called advanced metering infrastructure (AMI). Smart meters 208 allow full two-way communication and provide more accurate and convenient recording of electric energy consumption at residential locations 108, as well as other locations that consume electricity.

An additional aspect, predicated on the functionality of smart meters 208, is known as the home area network (HAN). In an exemplary HAN, smart meters 208 serve as a central point for collecting and disseminating information from other household devices and appliances related to the household's energy consumption.

Remote field devices 209 are also included within the SCADA communications architecture 200. The remote field devices 209 include components such as remote terminal units (RTUs) 210, phasor measurement units (PMUs) 212, PLCs 214, and intelligent electronic devices (IEDs) 216. These remote field devices 209 monitor system data and initiate programmed control activities in response to input data and alerts. Remote field devices 209 are controlled by control centers, such as control centers 218, within utility companies. Regional transmission operators/independent system operators (RTOs/ISOs) communicate with each other and with substations 220 in order to maintain balance between power generation and demand, maintain voltages and frequencies, respond to changing conditions, provide real-time power market access, etc. This communication is facilitated via communication links 222 between components of the SCADA communications architecture 200. Many cyber-security vulnerabilities exist in SCADA and other control systems.

FIG. 2B is a block diagram illustration 250 depicting the extensive and diverse use of ICS across different aspects of the electric grid. The extensive and diverse use of ICS across the grid represents potential access points for cyber threats. ICS generally provide potential attack paths for cyber attackers. As understood by those of skill in the art, there are many known vulnerabilities associated with such communication media and communication protocols. The power grid is increasingly connected to the Internet. The links that provide this connectivity, such as communication links 222, have inherent security weaknesses.

The size and dynamic nature of the power grid make it particularly difficult to estimate risk from cyber attacks. Cyber security risk is difficult to measure even in a static environment because it is a complex function of threat, vulnerabilities and consequences. A threat includes an unpredictable, intelligent adversary, dynamic vulnerabilities that are difficult to identify, and the specific consequences of a successful cyber attack are difficult to predict.

National level data indicate that, on average, 15 new publically disclosed vulnerabilities to critical infrastructure systems surface each day. About 12% of these new cyber security vulnerabilities (according to estimates) apply to control systems, such as the control systems architecture 200. Stuxnet, which was first reported in June 2010, was the first computer worm to target critical energy infrastructure. It was also the first computer worm that could allow an attacker to change the behavior of a very specific type of PLC, while hiding its own presence. Stuxnet, which represents only one of the cyber security vulnerabilities, infects PLCs by subverting software applications needed to reprogram these devices.

Identification and authentication represents another cyber security vulnerability class. As understood by those of skill in the art, identification and authentication represents the process of verifying the identity of a user, process, or device, as a prerequisite for granting access to resources. Although identification and authentication represents another one of the more widely acknowledged security vulnerabilities, additional vulnerabilities exist. These additional vulnerabilities include, for example, information and document management, media protection, physical and environmental security, personnel, platform software and firmware, as well as many others.

Conventional computing and processing systems are inadequate to provide cyber security protection for the aforementioned critical infrastructure systems. For example, conventional computing and processing systems cannot adequately prevent cyber crime, malicious theft, eliminate fraud and waste, or resist concerted attacks on utility and other critical infrastructures. As understood by those of skill in the art, conventional approaches for providing IT system cyber security include approaches such as firewalls, intrusion detection systems (IDS), intrusion prevention systems (IPS), demilitarized zones (DMZ), virtual private networks (cryptographic), antivirus systems (anti-malware), network admission control (NAC), etc. Most of these conventional approaches require a significant manual effort and include variations of behavior modeling techniques, pattern analysis, statistical analysis, profiling, sample auditing, etc.

Although traditional IT systems (e.g., networks), also known as enterprise networks, and ICS systems (e.g., networks) overlap in terms of technology, distinctions exist between adequate enterprise system security and adequate ICS system security. With increasing frequency, many well-known companies and organizations are making news due to security breaches in their enterprise Network Systems. Enterprise systems from organizations such as the CIA and the Department of Defense, as well as companies such as Sony, Google, EMC, Symantec, Citigroup, and others are seemingly breached with relative ease. These breaches illustrate their very real cyber security vulnerabilities. The cyber security challenges are even more daunting, however, for ICS systems by comparison with the dangers faced by enterprise systems.

Fundamentally, the objectives of enterprise networks differ from the objectives of ICS networks. For example, confidentiality of data in enterprise networks is of paramount importance. Several studies cite the theft of intellectual property, identity theft, and financial organization theft as the top three threats from hackers to such networks. The overall threat, of course, is that the confidentiality of potentially valuable data in these three areas will be breached. On the other hand, the goal of availability is of paramount importance in ICS networks.

As a result, many ICS networks are devoid of the most current software patches. While installing such patches might help address security issues, many of these patches require significant downtime to be installed as servers reboot and patches are integrated into the operation of the ICS networks. ICS networks are often unable to sustain lengthy interruptions of critical process phases to accommodate application patches. Even if the application patches help address security issues, many application patches create problems upon installation. For example, patches may still contain bugs or cause conflicts with other parts of ICS networks.

The actual hardware components and infrastructure of ICS networks are traditionally more fragile, and older, than similar components in enterprise networks. Consequently, routine procedures, such as vulnerability scans, have been known to shut down many of these fragile components that are associated with ICS networks. Additionally, antivirus applications are not used in many ICS networks, because often operating, maintaining, and updating many of these applications can also require significant downtime of the network.

Another example of the unique challenges associated with conventional ICS network cyber security, is that many of the machine-to-machine communications do not involve a user. As a consequence, many of these communication sessions suffer from poor authentication and authorization procedures. Many ICS networks also lack adequate password management and sufficient cryptographic support. Studies have also found that in many ICS networks, audit logging procedures for security related actions are nonexistent.

Regardless of the architecture of a given system, whether the system is an ICS network or sophisticated enterprise computing platform, most of the conventional safeguards share a common approach to providing security. The common approach is that these conventional safeguards mostly focus on data stream comparisons and historical evidence to determine if a threat is present. This type of in-line, historical data comparison is often too little, too late, when faced with the relentless and ever-changing threats posed by hackers, organized crime, disgruntled employees, competitors, terrorist organizations, nation states, and/or other parties that present threats to such systems.

Using these conventional historical data comparison techniques, utilities, other critical infrastructure sectors, businesses, and governments remain vulnerable because these conventional techniques provide inadequate protection from current cyber-threats.

### BRIEF SUMMARY OF THE EMBODIMENTS

What is needed, therefore, are methods and systems that overcome the aforementioned deficiencies, particularly with respect to the unique cyber security challenges associated with ICS networks. More particularly, what is needed are methods and systems that provide a holistic, systemic approach to services and processing. What is also needed are methods and systems that monitor and examine computing and automated processes that are about to be executed, and then compare them to predefined and allowed services.

Activities falling outside authorized critical infrastructure processes and services are flagged as anomalies. This shift in the way computing and processing of services are managed provides a more efficient and secure form of preventing security failures in critical infrastructure systems, such as the electric grid.

A critical infrastructure process includes a collection of related, structured activities in a chain of events. These events together produce a specific service or product for a particular customer or customers. The design of the critical infrastructure process can be represented using various modeling technologies. Once modeled, the critical infrastructure process can be automated using an engine or set of engines (critical infrastructure process engines.) The automation is optional. For example, only one part of the critical infrastructure process may be automated or even none of the process may be automated. The state of the critical infrastructure process is changed every time an event occurs and the critical infrastructure process ends when a final state is reached.

In conventional audit methodologies, sample data is retrieved and analyzed manually by a third-party team of domain experts. The result of such audits is an audit report that confirms or rejects the assumption that the process is being executed according to the design specifications for the network. This process is not automated. Consequently, the process is not optimized for real time identification of critical infrastructure process violations.

One conventional approach to identifying business process violations can be referred to as machine-centric or data-centric. When completed, process data sets are matched to predefined discovered violation data patterns to identify a violation in process operations. Using this approach, human consultants and analysts attempt to link the collected data sets to possible quality, performance, and/or security violations. Additionally, with this approach the process violations cannot be prevented nor can the process violation be guaranteed. In this approach, for example, the number of violation data patterns to be matched is so large as to be practically almost infinite, usually exceeding 10²³ patterns, each of which requires processing and analysis.

Embodiments of the present invention, however, use a process-centric approach to increase system security. Using this process-centric approach, according to the embodiments, only authorized process event patterns are monitored. Using this approach, those events that do not follow the authorized event process patterns become violations in the process operation. Therefore, this approach can prevent process violations, such as unauthorized access to electric grid networks. Prevention is possible because the approach of the embodiments is proactive—not simply relying on hindsight to repair attacks that may potentially cause considerable harm before the system realizes a threat exists.

An additional advantage of this approach is that the number of authorized process event patterns to be monitored and mediated is usually a smaller more manageable number.

Embodiments of the present invention, under certain circumstances, provide a method for improving security in an electrical grid network. The method includes configuring a lifecycle map associated with an operation in the electrical grid network, the lifecycle map including at least a start configuration, a final configuration, and a plurality of valid events arranged to link the start configuration and the final configuration, the start configuration and the final configuration corresponding to particular states of the electrical grid network. The method also includes monitoring at least one of messages and device configurations in the electrical grid network to detect one or more live events associated with the operation and comparing the plurality of live events to the lifecycle map to identify an anomaly in the live events.

Embodiments of the present invention are particularly well-suited for application to ICS, such as those deployed the electric grid. Given the distinction between ICS security and enterprise systems security, embodiments of the present invention are perfectly suited to accommodate the security nuances of ICS and provide cyber security coverage in situations where traditional cyber protection strategies only provide suboptimal, limited, or flawed protection.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1 is a block diagram illustration of conventional systems that comprise the U.S. electrical grid.

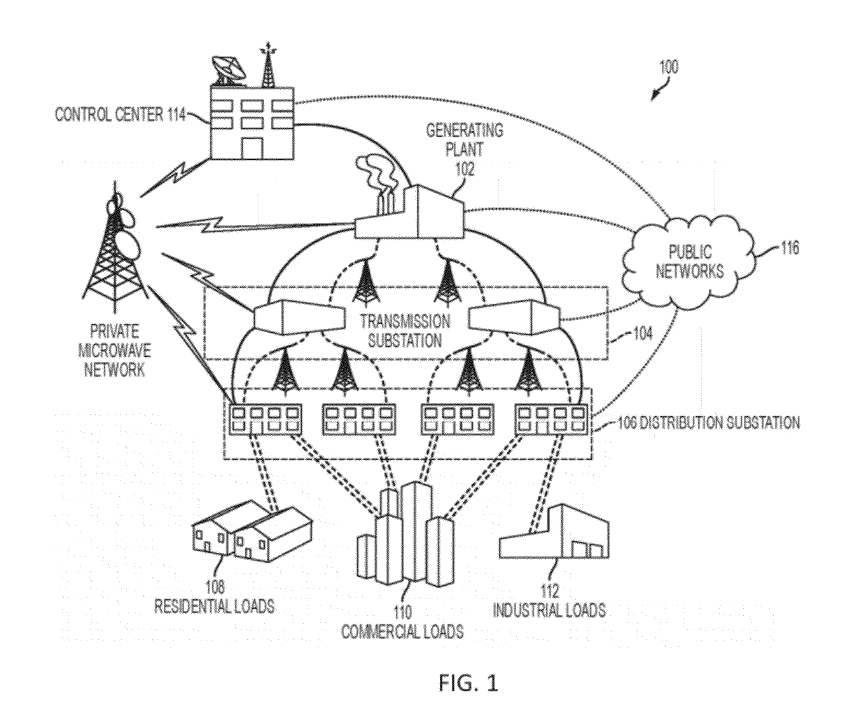

FIG. 2A is a block diagram illustration of SCADA communications infrastructure used in electric grid systems depicted in FIG. 1.

FIG. 2B is a block diagram illustration 250 depicting the extensive and diverse use of ICS across different aspects of the electric grid.

FIG. 3 is a schematic block diagram of an automated process audit system of one embodiment in accordance with the present invention.

FIG. 4 is a schematic block diagram illustration of the listeners component of the process audit system of one embodiment in accordance with the present invention.

FIG. 5 is a schematic block diagram illustration of the correlator component of the process audit system of one embodiment in accordance with the present invention.

FIG. 6 is a sample business process diagram as captured by modeling tools constructed and arranged in accordance with the embodiments.

FIG. 7 is a block diagram illustration of a live critical infrastructure audit system according to another embodiment of the present invention.

FIG. 8 is an exemplary illustration of how an anomaly security system might be implemented within the context of SCADA communications architecture depicted in FIG. 2.

FIG. 9 is an exemplary block diagram illustration 900 applying anomaly security system 700 to a plurality of business scenarios.

FIG. 10 is a flowchart depicting an overview of an exemplary application of the anomaly security system illustrated in FIG. 7.

FIG. 11 is a flow chart of an exemplary illustration of setting up a new office user in accordance with a first sequence of events according to an embodiment.

FIG. 12 is a flow chart of an exemplary illustration of setting up new office user in accordance with a second sequence of events in accordance with an embodiment.

FIG. 13 is a flow chart of an exemplary illustration of a sequence of events pushed when a new office user is set up as a mobile type user.

FIG. 14 is a flow chart of an exemplary illustration of a sequence of events that could trigger a process instance timeout.

FIG. 15 is a flow chart of an exemplary illustration of an unauthorized alert in accordance with the embodiments.

FIG. 16 is a flow chart of an exemplary illustration complex event processing fault detection in accordance with the embodiments.

FIG. 17 is an illustration of exemplary service life cycle violation alerts in accordance with the embodiments.

FIG. 18 is an illustration of an exemplary process instance trending in accordance with the embodiments.

FIG. 19 is an exemplary illustration of process discovery in accordance with the embodiments.

### DETAILED DESCRIPTION OF EMBODIMENTS OF THE INVENTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

The present invention improves upon heretofore known audit systems by providing a real-time, automated critical infrastructure process audit system, and more particularly by providing a computerized process audit system that detects anomalies and provides audit trails based on event data received from one or more sources.

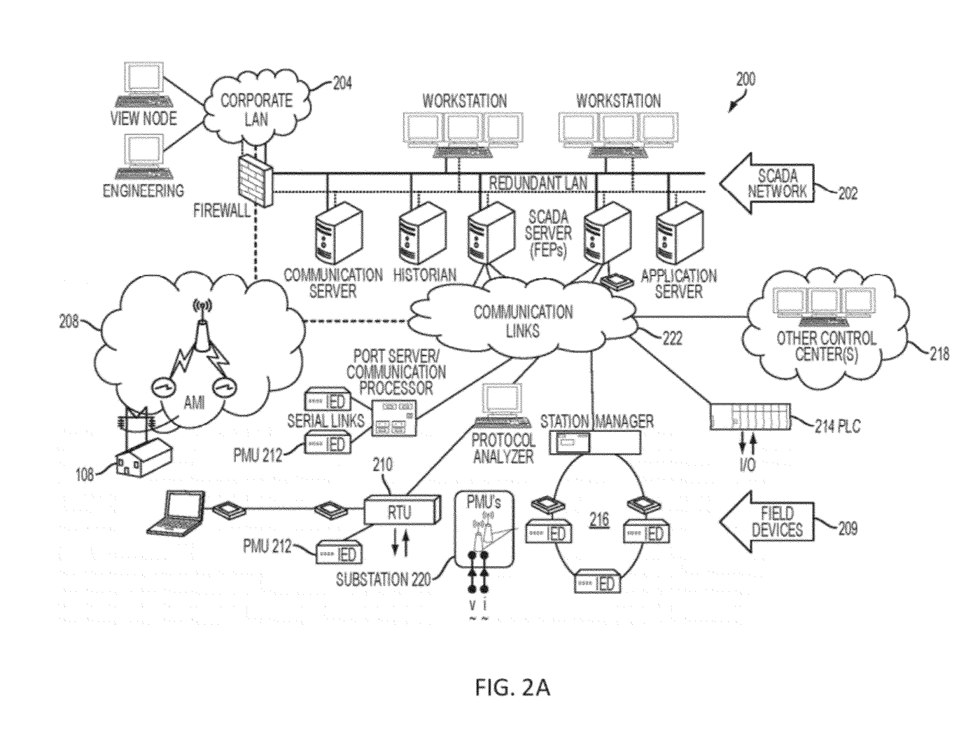

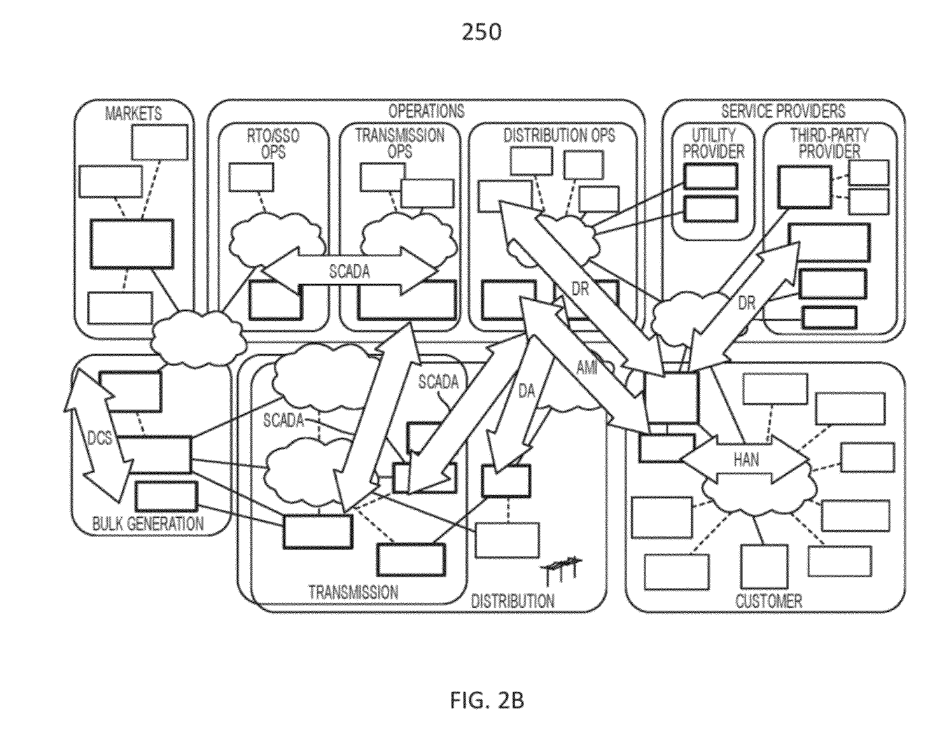

The present invention, in one embodiment, can be characterized as a system for anomaly detection in structured sets of events. These events, for example, can include activities such as accessing critical components of the system, such as SCADA network 202, smart meters 208, or field devices 209 of grid infrastructure system 200 of FIG. 2. The system, as is explained in greater detail below, employs a set of event listeners that collect raw event data, a correlator, and a notification component. The notification component sends audit events that are gathered from raw events grouped and annotated with correlation attributes. These audit events are processed or logged at a downstream location.

A correlator, as is discussed in greater detail below, loads the process definition from an external file. The file format of the external file can be one of a variety of the business process definition language formats, of which examples are provided below. The loaded process definition contains information about cause-effect relationships between the events specified. Also, it contains any guard conditions that are used to validate the events during the execution phase.

Event listeners can be real-time or historical and are configured using a mapping file. The real-time event listeners will trigger the correlation component immediately after an event is received. The historical event listeners simulate “virtual events” from historical storage (which may include information about past events, potentially stored in databases, log files, or similar storage architectures) and will not trigger the correlation component.

In another embodiment, the system further employs a causal pattern detection layer that applies pattern expressions on the audit grouped raw events contained in an audit event. The result of the pattern expression evaluation is considered to be a filtered instance of a causal audit event. Such filtering allows embodiments to determine which raw events are most important to focus on during further processing. The filtered audit events are then pushed through a notification component to be sent for further processing at a downstream location.

In yet another embodiment, the system further employs a behavior analysis layer that monitors changes in the model associated to the audit event flow. This behavior analysis layer collects data to build a clustering model for the configured fields from the audit event. After enough data is collected and a model is built, this layer will signal (without human intervention) when an input (audit) event can be considered as a large and/or significant variation from the model. Periodically, when new data is available, this processing layer will update its model, which adapts the model to the changing environment.

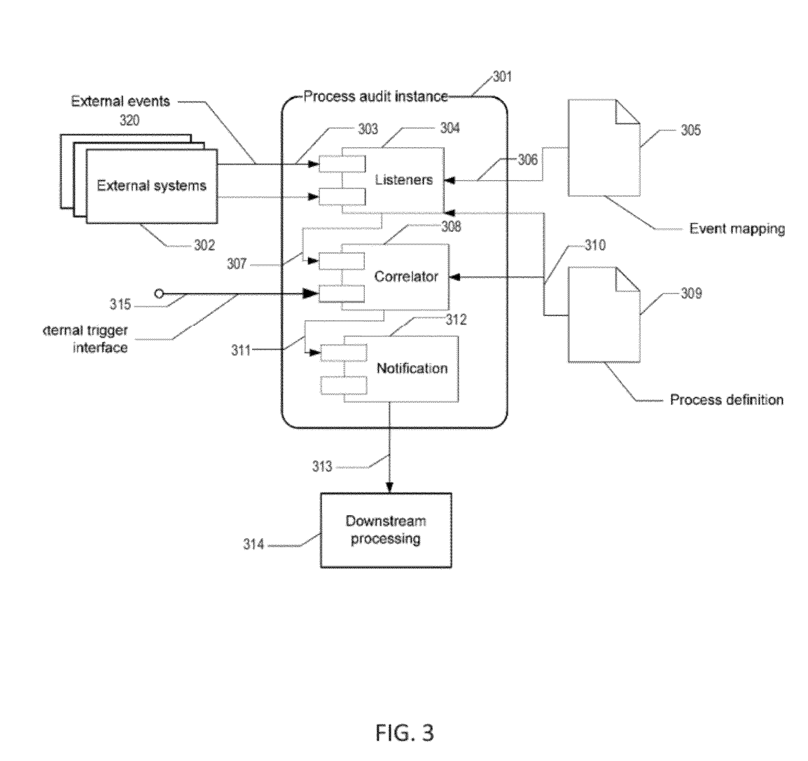

Referring first to the illustration of FIG. 3, a block diagram is shown of an automated critical infrastructure audit system 300 and method in accordance with one embodiment of the present invention. The automated critical infrastructure process audit system is broken in sequential processing blocks: Listeners 304, a correlator 308, and a notification module 312.

During a critical infrastructure activity, external systems 302 involved in the choreography of actions and events 303 exchange messages and generate, or update, data in various storage mediums. External systems 302, by way of example and not limitation, could include the applications and actions of operators of smart meters 208, users or corporate LAN 204, or operators of field devices 209 attempting to access SCADA network 202 of system 200 illustrated in FIG. 2.

The cause and effect relationships between the events that trigger state changes are captured using various modeling tools, in the form of a business process definition. This triggering of the state change/transition can be guarded by a condition that controls the state changing based on the result of a guard condition expression evaluation. The guard condition expression can include references to data internal or external to the critical infrastructure process. As noted above, the critical infrastructure process can include a variety of specific systems. However, for purposes of illustration, many of the descriptions contained herein are provided from the context of the electric grid.

This critical infrastructure process definition usually can be used for, but is not limited to, automating the critical infrastructure process execution, documentation or (as described in this invention) for audit purposes.

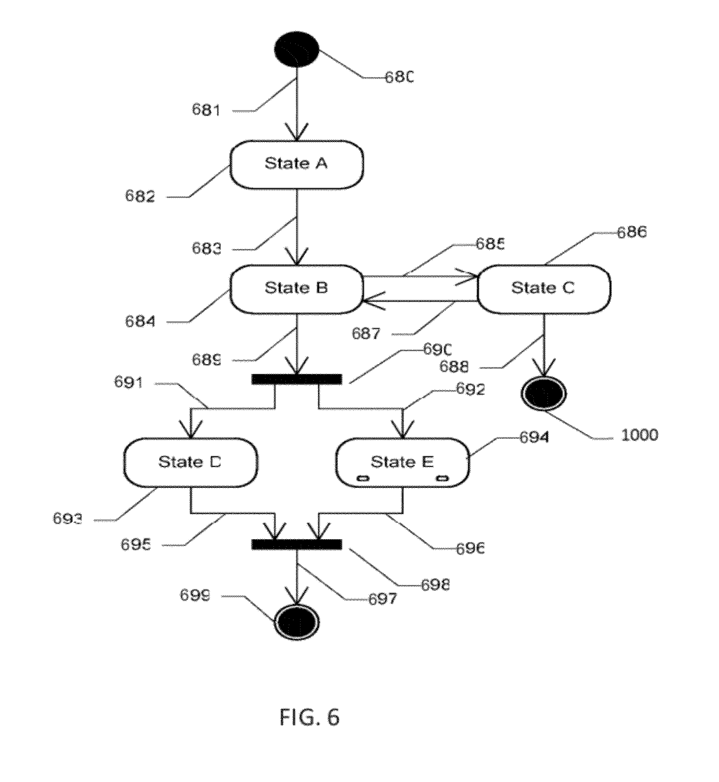

By way of example, FIG. 6 is an exemplary illustration of a critical infrastructure process comprised of initial state 680 (pseudo state), along with states 682, 684, 686, 693, and 694 (694 is a composite state, but the process audit will drill down and handle it as a regular business process). Also included are pseudo states 690, 698, final states 699, 650, and transitions 681, 683, 685, 687, 689, 691, 692, 688, 695, 696, and 697. Not specified in the illustration of FIG. 6 are trigger events associated with the transitions. Within the context of the system 200 of FIG. 2, a trigger event could be an otherwise valid event occurring outside of a predefined sequence.

For the critical infrastructure process audit system 300 to reach the events 303 that are generated by the external systems 302, the listeners component 304 is desirably configured by loading (306) event mapping configuration data 305 and guard condition expressions from the process definition 309. This data specifies how the process audit system will access middleware and how to gain access to the external events 303.

After the listeners component 304 has established the connectivity to the event sources throughout the enterprise, upon receiving of an event, the listeners component 304 will manage the storage and access of the event payload.

The listeners 304 component will notify (307) the correlator 308 when a new event, or an anomaly, was detected at the listener level. The correlator 308 component loads (310) the process definition 309 as configuration data. When triggered by the listeners 304 component, or externally through an external trigger interface 315, a correlation routine will be performed on the available data. The result 311, in form of event sets assembled together by the correlation component, according to their receive order and relationships defined in the process definition, is supplied to the notification component 312. Notification component 312 converts the event sets to an external format that is pushed (313) for further downstream processing 314.

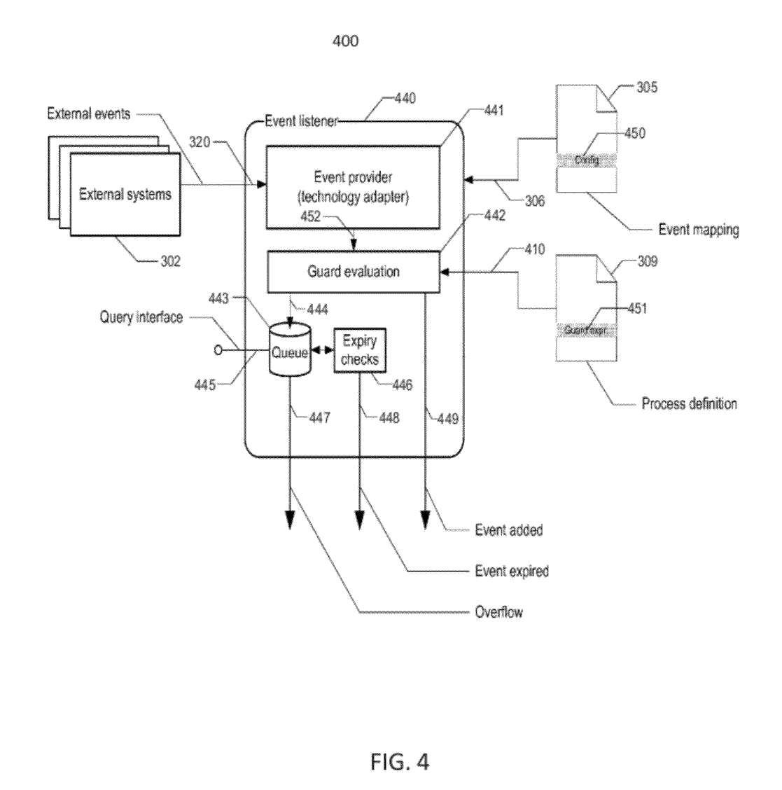

FIG. 4 is a block diagram 400 of the listeners component 304 of the critical infrastructure audit system 300 of one embodiment in accordance with the present invention. In FIG. 4, architecture for the listeners component 304 can include multiple event listeners 440 created according to the configuration data.

By way of example, each event listener 440 can include the following processing blocks. An event provider 441 connects to a physical system and extracts (listens for) events. The event data will be converted to a normalized format internally. A guard evaluation module 442 loads (410) the guard condition 451 from the process definition 309. However, this aspect of the operation of embodiments is only relevant if there is a guard condition defined for the transition associated with the configured event. The data available as the event occurs can be accessible to the guard condition expression evaluation.

In addition, the system 304 can be configured to expand guard condition 451 expression evaluation scope to the payload of all related events pre-correlated by the correlator component 308. External data can be accessed during the expression evaluation. The language and preprocessing directives can be specified in the process definition 309 data. The component 442 can load the appropriate expression evaluator and set up the required resources for expression evaluation. Queue 443, for example, provides historical storage for the events that pass the guard expression evaluation. It also offers a query interface 445 that can be used to locate and consume an event.

Typically, a limit is enforced on the number of events stored into the queue 443. When this limit is exceeded, an overflow event 447 will be generated. The implementation of the queue is configurable and is plug-in based. Expiry checks component 446 are performed for queues that store events that have an expiry period associated with them. Expiry checks component 446, in order to perform this function, periodically verifies the contents of queue 443 for events that have exceeded their preset storage time. Expired events are removed from the storage queue 443 and tagged as being expired. Subsequently, an expiry 448 event will be generated.

When an external system 302 generates an event, the event provider 441 receives and converts the event into a normalized format configurable for guard expression evaluation. If there is no guard condition associated with the corresponding transition, the guard evaluation 442 component assumes that there was a successful validation of the transition.

If the guard condition evaluation was successful, the event will be stored in the associated queue 443 for later retrieval. If an expiry period is configured for this event listener, the contents of the queue 443 are verified periodically by expiry checks 446 so that no event older than the expiry period remains in the queue. If an event is found to be expired, it is removed from the queue 443 and an expired event 448 is generated.

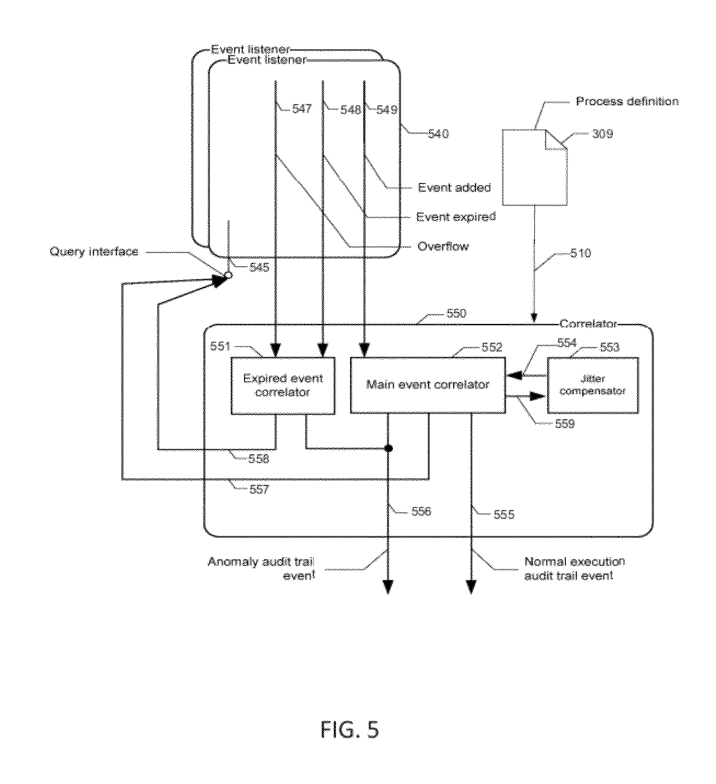

FIG. 5 is a schematic block diagram illustration of the correlator component of the process audit system of one embodiment in accordance with the present invention. In FIG. 5, correlator component 550 includes a main event correlator 552, and an expired event correlator 551. Since the order of the events is relevant for any process audit, such as for a real-time business process audit, a jitter compensator 553 is provided to delay processing to accommodate any uneven propagation delays in corresponding middleware systems.

By way of example, the correlator 550 loads (310) the process definition data 309 to be used during the correlation of the events 447, 448, 449, produced by event listeners 440. Upon receipt of an added event 449, the main event correlator 552 will determine whether the associated transition from the process definition has as a target, such as a final state (for example, final state 699).

If there is a target, the main correlator 550 will traverse the process definition 309 (also referred to as “lifecycle map”) in reverse, towards the initial state 680 of the critical infrastructure process. For every transition, the correlator will check the event listener 440 (associated with the event for that transition) for available event data. This query 557 is performed through query interface 445.

When the traversal of the process definition is completed, all identified events are marked as consumed and a normal execution audit trail event 555 is generated. This normal execution audit trail event 555 contains the list of all events causally related according to the critical infrastructure process specifications 309. If, during the process traversal, an instance of an event specified in business process definition 309 in is not found in the associated event listener 440 queue (queried through the query interface), the processing is suspended 559 by the jitter compensator 553. When the jitter period has expired, the correlation resumes 554. If at that time, the required event data is still not found, the correlation process ends and an anomaly audit trail event 556 is generated. This event desirably has structure similar to normal execution audit trail event 555 but is flagged by an “anomaly=true” attribute.

On receipt of an expired event 448, or overflow event 447, the expired event correlator 551 will start the correlation process by traversing the process definition 309 in upwards towards the initial state 680 of the process and downwards, towards the final state 699. For every transition, the expired event correlator 551 will check the event listener 540 that is associated to the event for that transition for available event data. This query 558 is performed through the query interface 445. When no more events are found, the process traversal is completed, all identified events are marked as consumed and an anomaly audit trail event 556 is generated. This anomaly audit trail event 556 contains the list of all events causally related according to the business process specifications 309. It will be flagged by an “anomaly=true” attribute.

Referring back to FIG. 3, notification component 312 accepts events 311 of type anomaly 556 or normal 555 execution audit trail and translates their content into a native middleware message format, or similar representation, using, for example, a user configurable technology adapter. The resulting message 313 is pushed for downstream processing 314 on external systems.

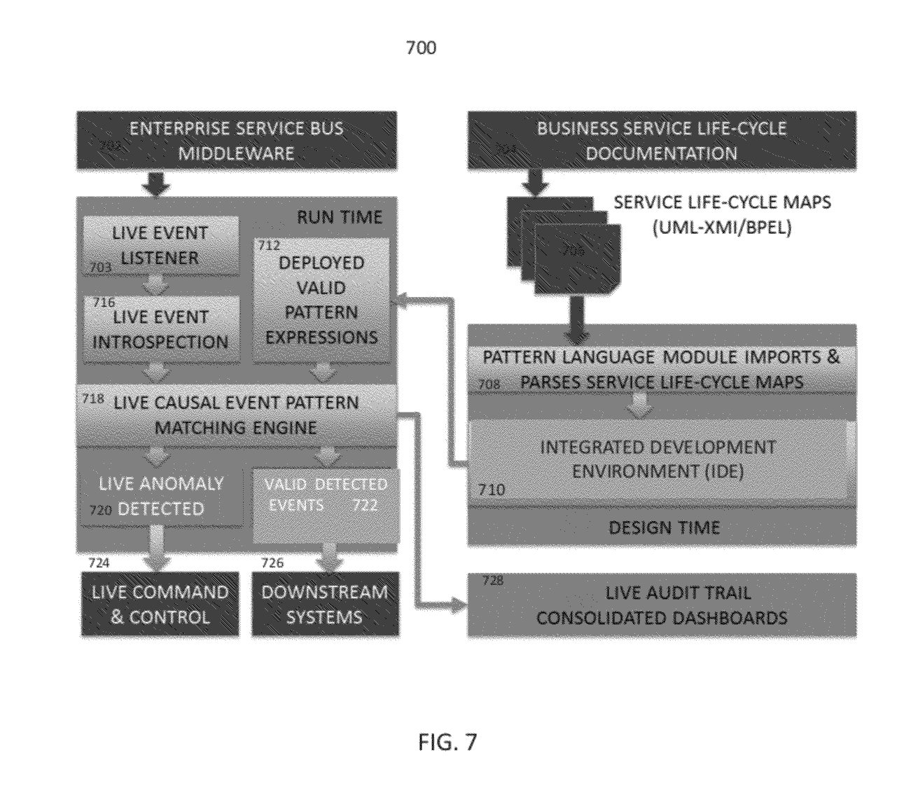

FIG. 7 is a block diagram illustration of a live service anomaly security system 700 constructed in accordance with another embodiment of the present invention. By way of background, embodiments of the present invention provide a unique automated solution to business process operations and network security generally, and ICS network security particularly. The embodiments effectively and accurately manage the quality, performance and security of the underlying critical processes associated with the operation of a business, infrastructure or other network.

In one illustrative embodiment, process data sets are matched to predefined discovered violation data patterns to identify a violation occurring in process operations and/or processes, such as remotely programming PLC 214 of FIG. 2A. Embodiments of the present invention utilize process definitions to mediate events on a live and potentially real-time basis to ensure that the quality, performance, security, and compliance of process operations is not compromised. Within the context of the present application, this concept is referred to as anomaly detection. Other embodiments of the present invention ensure that the authenticity of a company's defined processes and the discovery of unknown or unauthorized processes in the enterprise's operations are preserved so as to guard the security of protected systems.

Live detection of system anomalous events, as achieved in the embodiments, may require the processing of process maps (lifecycle maps) by extending existing software languages and/or hardware infrastructures to support causal operator relationships. System anomalous events can create errors that prevent meeting business end objectives or compromise the process, the system, and/or the network. It is therefore desirable to test each live service system event for an anomaly. This system of detecting abnormal service behaviors, as is performed in the embodiments, not only protects against intentional malicious actions, but also helps to prevent fraud, waste, and software inefficiencies or errors. In this way, live anomaly detection protects against terrorism, fraud, risk, and cyber-crime within the entire utility grid, internet, public, commercial, and financial services sectors.

The exemplary anomaly security system 700 illustrated in FIG. 7 allows live detection of system anomalous events by the operation of the embodiments. In FIG. 7, system 700 monitors the causal relationships of events related to business processes. More specifically, during operation, embodiments of the present invention begin with development of detailed descriptions of all known, valid, and/or authorized business processes and operations associated with an enterprise.

Within the context of the present invention, the enterprise refers to operation of the electric grid, another critical infrastructure sector, a business, the cloud, or a similar environment that needs appropriate protection. On a day-to-day basis, the operation of each of these enterprises can be defined by the occurrence of hundreds or thousands of events. All valid and authorized business processes and operations are catalogued in process maps (also known as “lifecycle maps”), stored within the system, and used for comparison with live events.

An individual event (e.g., business operations) can include, by way of example only, controlling the activities for turning the off and on switch in smart meters, remotely programming PLC 214 of FIG. 2, or managing activities for privacy or intellectual property information access. The present invention is also applicable to services and operations related to cloud computing. Other examples include assuring and safeguarding the activities in the production cycles for food, medicine, vehicles, fuel, etc. For example, such activities could include ensuring that certain activities are compliant to their business operations service definitions to achieve quality standards.

As can be appreciated by one of skill in the art, many of these events represent valid business operations that are part of the service cycle of the enterprise. Other events, however, represent invalid business operations. Attackers may attempt to introduce into a protected system events that are not part of the business operations service cycle (i.e., invalid events) but that are replicated/duplicated, cloned, or otherwise disguised or modified for the purposes of gaining unauthorized control of a protected system. Such events are known as external anomalous events.

By contrast, events that are introduced properly, but simply do not follow business operations service cycle definitions are known as internal anomalous events. For example, external anomalous events could be responsible for security, fraud and privacy violations. Internal anomalous events could be responsible for operations risk, quality and compliance issues. Business operations service cycles can be compromised by external or internal anomalous events that can severely impact, or completely cripple, the end objectives of the enterprise. Hence, it is important to protect both types of events.

Illustrative embodiments of the present invention, such as the anomaly security system 700 of FIG. 7, observe, watch, and/or witness all events live with reference to the valid business operations service lifecycle definitions. In accordance with embodiments of the present invention, the act of observing/watching/witnessing live events creates a business context required for making a binary decision (in which each event is considered valid or invalid) about the validity of an event in the business operations service cycle that is already in progress. For example, an event is evaluated based on the preceding events as well as all other events required for completing a particular process.

To signal a completion of an activity in the operations service life cycle, and to trigger other activities, the system deploys networked applications in the enterprise to generate service system events and alerts that trigger other applications until reaching the end objective. In this way, the service life cycle is protected through each step.

While much of the discussion above is within the context of the electric grid, and related processes thereof, embodiments of the present invention can also be applied to the cloud, financial transactions, analysis of stock market data, detection of insider trading, detection of Medicare fraud, as well as many other applications where preserving the integrity of information exchange in a networked environment is important and/or desirable.

Returning to FIG. 7, system 700 includes an enterprise service bus middleware module 702. Middleware service bus module 702 provides an interface to the outside world. Executing via middleware service bus module 702, system 700 ultimately loads events into an integrated development environment (IDE) engine, discussed in greater detail below, for correlation. All business processes, definitions, activities/events are defined and assembled to produce business service lifecycle documentation 704. The business lifecycle documentation 704 is used to produce process lifecycle maps 706. The process lifecycle maps 706 define what is happening in the business operations service cycle of the enterprise.

Embodiments of the present invention resolve the shortcomings of the conventional approaches by providing a system capable of analyzing causal relationships between past events and present events. The embodiments, for example, facilitate determination of vital causal relationships. These causal relationships permit creation of an entire process graph. The causal relationships are defined by standard formats such as, for example, unified modeling language (UML), extensible markup language (XML), business process execution language (BPEL), and other standards that enable users to define the process graph of how the workflow within an enterprise should occur.

Thus, the first step in using the system 700 will be for a business to define all of their enterprise operational processes in a sufficient level of detail using, for example, UML mapping. The UML maps are then used to create a state machine, discussed below, that is loaded into the system 700 and monitored. Such a state machine can be used not only to monitor network activity in a critical infrastructure sector, but it can also be used to monitor large numbers of events that are a part of system operation.

For example, the state machine may monitor processing of loan applications for anomalies or irregularities. If the loan application process consists of three events that occur in a specific order, then those three events will be defined in the UML maps. Known processes related to the electric grid can also be defined in terms of a UML map. If events occur that are outside of the defined processes, these events will be identified as anomalous. In this manner, intrusions and process failures can be prevented.

The process life-cycle maps 706 provide the conditions, timing and sequences (i.e., smart data and associated logistics) for all the valid activities in the service cycle of the business enterprise. The live service anomaly security system 700 matches live events against only the known valid service lifecycle pattern maps 706 to determine if the event is anomalous.

Conventional approaches matches events against the known invalid patterns to determine if exceptions, or anomalies, occurred. In the embodiments, events that do not follow the conditions, timing and sequencing defined in the service lifecycle maps 706 are flagged as anomalous events to prevent significant or crippling impact to the enterprise. The events defined in the process lifecycle maps 706 provide start points and ending points for business operations in events.

A pattern language module 708 and an IDE module 710 cooperatively function as a state machine that facilitates loading of the process lifecycle maps 706 into the live service anomaly security system 700. The pattern language module 708 imports and parses service lifecycle maps 706 into a pattern language, examples of which have been provided. In other words, an individual pattern language is constructed for event patterns and imported into the system 700 to enable automatic identification of valid event patterns.

The IDE engine 710 processes the parsed service life-cycle maps 708 and converts them into the valid service execution patterns using an exemplary pattern language, discussed more fully below. In one embodiment, IDE 710 is a graphical user interface (GUI) that enables system 700 to import the process maps into system 700 and to generate event patterns later used to produce a live audit trail dashboard 728. IDE 710 passes all valid and tested process maps to its repository 712 of valid pattern expressions.

A pattern matching engine 718 performs live, causal event pattern matching of detected events, captured via live event listener module 703, and known valid process life-cycle events imported via IDE 710. Event listener module 703 can include, for example, J2EE connector architecture (JCA) resource adapters, and is configured to capture the live events off the service bus 702. These events are provided as inputs to live event pattern matching engine 718. Details of the pattern matching process that is executed by pattern matching engine 718 are described more fully below.

In accordance with embodiments of the present invention, pattern matching engine 718 analyzes the start points and end points of the event patterns by way of a time causality routine configured to identify, for example, parallel paths helpful in determining why a particular process proceeds from one direction to another path in the process map. An exemplary implementation of a causality routine is discussed in further detail below.

By way of example, when a hacker enters a communications network, such as smart meter network 208 of FIG. 2, this activity represents a hacker process. That is, the hacker's intrusion is not merely a single event, but is a series of events, or a hacker process. To locate the hacker, one must first identify the hacker's process. The causality routine configures all of the existing events for input into the system 700 via the pattern language module 708 and draws conclusions that it has derived, based upon an analysis of those events. In one illustrative embodiment, the causality routine performs computations of uniquely identifiable known events to determine proper causation needed to produce events patterns.

Event patterns, for example, can be messages on the enterprise service bus 702 that represent the invocation of services or process calls. In one example, event patterns could include an event from an electrical transformer (A), plus an event from a switching station (B), plus an event from a utility control room (C). The anomaly security system 700, using causal operators, determines whether these events have occurred in the valid order as specified in the process lifecycle maps 706 and pattern language module 708. For example, the process lifecycle maps 706 specifies that a valid pattern includes the electrical transformer event, followed by the switching station event, followed by the utility control room event, in that specific order. In order to make this ordering determination, the system 700 performs computations that efficiently solve causation expressions such as: A causes B, independent of C. Such computations lead to guaranteed logical conclusions about the relationships between various events.

In one exemplary embodiment, a compiler is configured to extend the Java language to include causal operators. This compiler may be written and applied to system planning software development tools such as, but not limited to, the RAPIDE object oriented event-based architecture descriptor language (ADL). A reference specification may be used to create the extension to Java to be able to create the event patterns automatically. Using this approach, it is no longer necessary to first identify anomalies or invalid events.

Embodiments of the present invention have the capability of identifying events that match the correct patterns. Events that do not match the correct patterns are by definition, anomalous or invalid. In the example above, if an examination of an event pattern including that switching station event (B) along with control room event (C) was being performed, but the transforming event (A) had not yet occurred, then the event pattern including only events (B) and (C) would be considered invalid due to the discrepancy in when event A had been detected to occur.

An event pattern including only events (B) and (C) would be considered invalid because the transforming event (A), which causes the switching station event (B), is missing from the event pattern. Since only event pattern (A), (B), then (C) is permissible, any event including only (B) and (C), by definition, would be impermissible. In other words, knowing the correct process enables one to know the correct sequence of events from start to end. Such a sequence includes which events are present, as well as acceptable sequences of those events.

All event patterns that do not match a correct sequence are automatically deemed anomalous or invalid. All other conventional approaches and software systems, including the object oriented event-based RAPIDE software are unable to accurately and efficiently perform this type of pattern matching. That is, these conventional approaches are unable to accurately and efficiently solve the expression: event A causes event B, independent of event C.

Exemplary causation computations performed in the embodiments are provided below, although the present invention not limited to the specific computations. Computations consist of events, which are uniquely identifiable tuples of values. The Event( ) type is defined in the predefined types LRM.

The identity relation == is a congruence relation; that is, it satisfies the equivalence axioms:

(∀event e)e==e (reflexivity)

(∀event e₁,e₂)e₁==e₂→e₂==e₁ (symmetry)

(∀event e₁,e₂,e₃)(e₁==e₂̂e₂==e₃)→e₁==e₃ (transitivity)

This relation also satisfies, as well, the functional substitutivity axiom schema, for every n-ary function ƒ and every I from 1 to n:

(∀event e₁,e₂)(∀z₁,z₂, . . . zₙ)e₁==e₂→ƒ(z₁, . . . , zᵢ,e₁,zᵢ+1, . . . , zₙ)==ƒ(z₁, . . . , zᵢ,e₂,zᵢ+1, . . . , zₙ) (functional substitutivity)

A computation is a set of events, where == is the equality operator on set elements. The events in a computation have the preorder relation ≦c (causal preordering) and the preorder relations ≦t (temporal preordering, for each Clock t); and the equivalence relation, =c (causal equivalence) and the equivalence relations =t (temporal equivalence). =c and =t are equivalence relations; that is, they satisfy the equivalence axioms of reflexivity, symmetry and transitivity (as shown above). The relations ≦c and =c together satisfy the preorder axioms:

(∀event e)e≦_{c}e (reflexivity)

(∀event e₁,e₂)(e₁≦_{c}e₂̂e₂≦_{c}e₁)→e₁=_{c}e₂ (antisymmetry w.r.t.=_{c})

(∀event e₁,e₂,e₃)(e₁≦_{c}e₂̂e₂≦_{c}e₃)→e₁≦_{c}e₃ (transitivity)

(∀event e₁,e₂,e₃)(e₁=_{c}e₂→e₁≦_{c}e₃) [symbol] e₂≦e₃ (left substitutivity)

(∀event e₁,e₂,e₃)(e₁=_{c}e₂→e₃≦_{c}e₁) [symbol] e₃≦e₂ (right substitutivity)

s;t and =t satisfy the same axioms. From these relations, the following associated relations can be derived: <c (causal ordering) and <t (temporal ordering). <c is defined in terms of $c and =c: <t is defined in terms of s;t and =t with the same axioms.

(irreflexive restriction)

(reflexive closure)

The equivalence relations of time and causality are consistent with the identity relation (this relationship is inferrable from the congruence of ==):

(∀event e₁,e₂)e₁==e₂→e₁=_{c}e₂

(∀event e₁,e₂)e₁==e₂→e₁=ₜe₂ (identity-equality consistency)

Causal ordering and temporal ordering have the following consistency relationship:

(∀event e₁,e₂)e₁<ₜe₂→ [symbol] (e₂<_{c}e₁)

(∀event e₁,e₂)e₁<_{c}e₂→ [symbol] (t.finish(e₂)<ₜt.start(e₁)) (causal-temporal consistency

A Computation C is a set of events. The notation C f=P to mean pattern P matched in the computation C is then used. The result of matching a pattern in a computation is a set of sets of events. Every such set will be a subset of C.

By way of example only, and not limitation, sample pattern language utilized in one of the illustrious embodiments of the present invention is as follows:

| | | |
|---|---|---|
| c\|= a | ≡ {{e} \| (e ε C) [symbol] (α ε β)$$matches(e, α)} | BasicPatterns^{a}, 2, 3c |
| c\|= p₁ → p₂ | ≡ {s₁ ∪ s₂ \| (s₁ ε (C \|= p₁)) [symbol] (s₂ ε (C\|= p₂)) | Sequence, 2.4.1 |
| | (∀e₁, e₂ (e₁ ε s₁ [symbol] e₂ ε s₂) → e₁ < c e₂} | |
| c\|= p₁ [symbol] p₂ | ≡ {s₁ ∪ s₂ \| (s₁ ε (C \|= p₁)) [symbol] (s₂ ε (C \|= p₂)) [symbol] | |
| | s₁ ∪ s₂ ε (C\|= p₁ → p₂) [symbol] | |
| | (∀e₁, e₂ (e₁ ε s₁ [symbol] e₂ ε s₂) → | |
| | [symbol] ∃ω (ω ε C) [symbol] (ω ∉ s₁ ∪ s₂) [symbol] | |
| | e₁ <_{c} ω <_{c} e₂} | Immediate Sequence, 2.4.2 |
| c\|= p₁ ~ p₂ | ≡ {s₁ ∪ s₂ \| (s₁ ε (C \|= p₁)) [symbol] (s₂ ε (C \|= p₂)) [symbol] | |
| | (s₁ ∩ s₂ \|=Ø} | Join, 2.4.3 |
| c\|= p₁ \|\|~ p₂ | ≡ {s₁ ∪ s₂ \| (s₁ ε (C \|= p₁)) [symbol] (s₂ ε (C \|= p₂)) [symbol] | |
| | (∀e₁, e₂ (e₁ ε s₁ [symbol] e₂ ε s₂) → | |
| | [symbol] (e₁ <_{c} e₂ [symbol] e₂ <_{c} e₁))} | Independence, 2.4.4 |
| c\|= p₁ or p₂ | ≡ (C \|= p₁) ∪ (C \|= p₂) | Disjunction, 2.4.5 |
| c\|= p₁ and p₂ | ≡ (C \|= p₁) ∩ (C \|= p₂) | Conjunction, 2.4.6 |
| c\|= p₁ ∪ p₂ | ≡ {s₁ ∪ s₂ \| (s₁ ε (C \|= p₁)) [symbol] (s₂ ε (C \|= p₂))} | Union, 2.4.7 |
| c\|= p₁ [symbol] p₂ | ≡ {s₁ ∪ s₂ \| (s₁ ε (C \|= p₁)) [symbol] (s₂ ε (C \|= p₂)) [symbol] | |
| | (∀e₁, e₂ (e₁ ε s₁ [symbol] e₂ ε s₂) → e₁ =_{c} e₂) | Equivalence, ?? |
| c\|= op(a₁,....,aₙ) | ≡ C \|= bₒₚ (p₁,....,fₙ) \|ₐ₁,...,aₙ^{p}_{1,...f}ₙ | Pattern Macros^{b}, 2.5 |
| c\|= (id : t in it rel op)f | ≡ if lit = [ν₁,ν₂,....νₙ]then | |
| | C \|= p\|_{ν}₁ⁱ_{d} op p \|_{ν}ₙⁱ_{d} | Iteration^{c}, 2.4.8 |
| c\|= (id : t)p | ≡ (s \|∃ν ε dt (s ε C \|= p\|_{ν}^{id})) | Placeholder Patterns^{d}, 2.4.9 |
| c\|= (p) | ≡ C \|= p | Parenthesized Patterns, 2.4.10 |
| c\|= p where b | ≡ if b then (C \|= p) else{ } | Guarded Patterns, 2.4.11 |
| c\|= p during (c,t₁,t₂) | ≡ C \|= p [symbol] (∃e₁,e₂ ε C \|= p) (∀e₃ ε C\|= p) | |
| | c.start (e₁) = t₁ [symbol] | |
| | (c.start (e₁) <= c.start(e₃)) [symbol] | |
| | c.finish(e₂) = t₂ [symbol] | |
| | (c.finish(e₂) >= c.finish(e₃)) | Timing Operators^{e}, 2.6 |

Software language expressions, such as those noted above, facilitate expression of express the correct relationships, and patterns, in a single manner. These correct patterns can be expressed in a fairly simple expression, such as event A causes event B, independent of event C. This relationship can be expressed in a single statement.

Returning to FIG. 7, pattern matching engine 718 forwards analysis of matching results to downstream modules. If an anomaly is detected, results are forwarded to live anomaly detection module 720. On the other hand, if no anomaly was detected, results are forwarded to valid detected events module 722.

A live command control module 724 automatically monitors invalid and anomalous events received from detection module 720 for isolation, examination, or other preventative measures, including eliminating the anomalous event entirely.

To signal a completion of an activity in the operations service life cycle, and to trigger other activities, the system 700 deploys networked applications in the enterprise to generate service system events that trigger other applications in downstream systems 726 until reaching the end objective. Alerts are generated for invalid and/or anomalous event patterns and displayed to the users or operators via live audit trail dashboards 728.

The anomaly security system 700 is not necessarily a replacement for conventional antivirus, firewall, and other security solutions. However, the anomaly security system 700 can reduce much of the security burden placed on these systems. The anomaly security system 700, for example, can reduce the need for these conventional systems to examine and compare every bit within data streams. Thus, these conventional systems can perform more efficiently (due to reduced processing demand) and are less vulnerable as they only need to process detected anomalies forwarded by the anomaly security system 700.

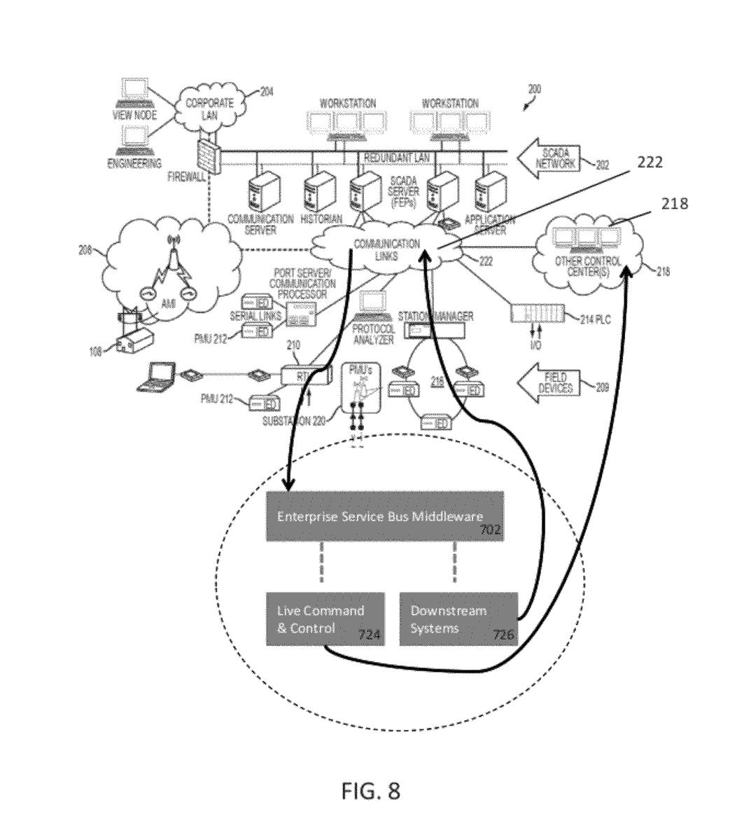

FIG. 8 is an exemplary illustration of how the anomaly security system 700 might be implemented within the context of SCADA communications architecture 200 shown in FIG. 2.

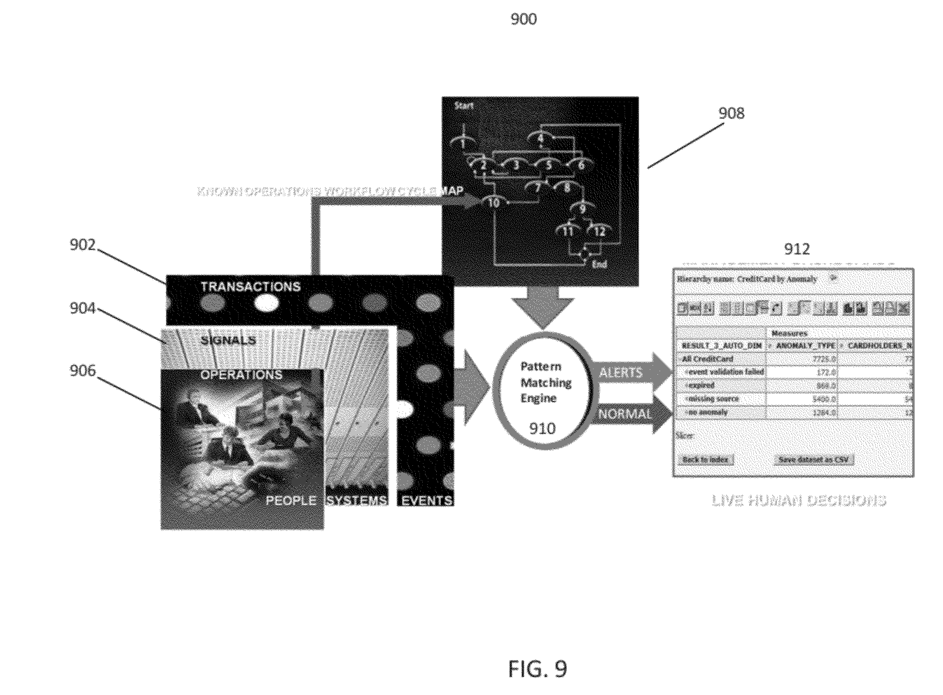

FIG. 9 is an exemplary block diagram illustration 900 applying anomaly security system 700 to a plurality of business scenarios. In FIG. 9, anomaly security system 700 is utilized to monitor multiple events including business enterprise transactions 902, a communication system signals 904, and business operations 906. The transactions 902, signals 904, and operations 906 are defined as known operations for any process cycle map 909. Pattern matching engine 910 monitors each of the events, comparing them with corresponding known event patterns 908. Results produced by pattern matching engine 910 are presented to a user via dashboard 912 in the form of alerts, allowing live human decisions to be made.

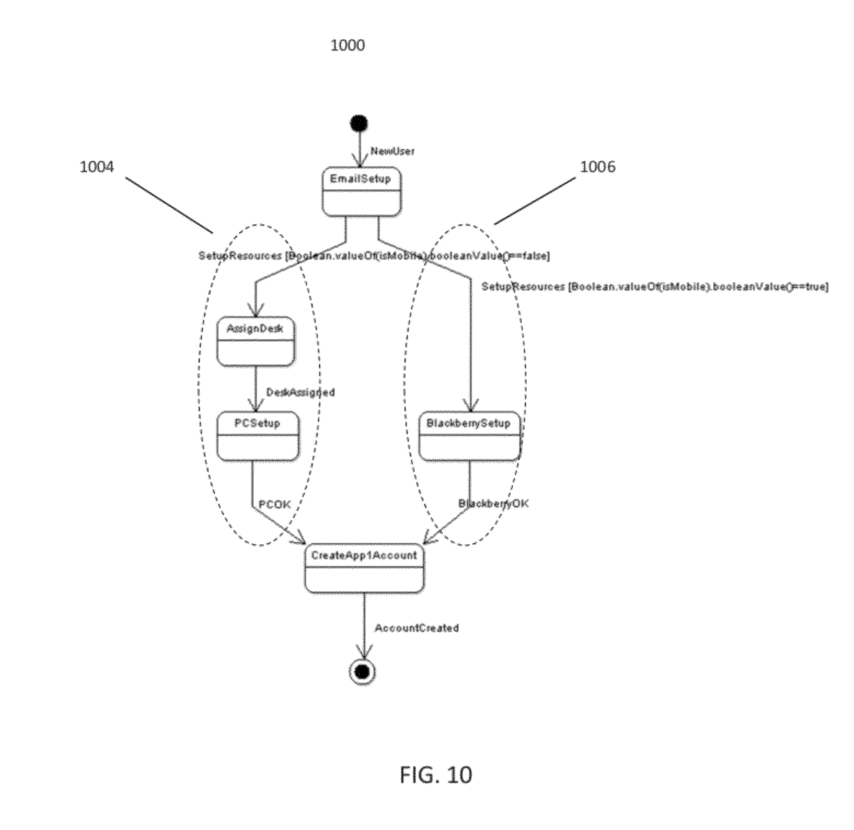

FIGS. 10-19 represent various steps of an example 1000 application of aspects of embodiments of the present invention. In FIGS. 10-19, the anomaly security system 700 is configured to monitor events related to a new RTO control center worker being assigned an office type desk computer system and a Blackberry personal digital assistant (PDA) computer to access, for example, communications links 222 of FIG. 2. By accessing communications links 222, the worker has access to all of the resources of SCADA communications architecture 200 of FIG. 2.

More particularly, in FIG. 10 a new office user is assigned a desk computer system in accordance with an event pattern (i.e., sequence of events) 1004. The new user 1000 is also assigned a blackberry PDA in accordance with sequence of events 1006. In the example 1000, system 700 performs a process audit of an imaginary employee provisioning process that activates the new user. The process assumes that two types of users are configured and both types use “Appl” as their primary application. To gain access to the application, an account will be created. For the “Office” type, a desk needs to be assigned after which a computer has to be configured with the appropriate operating system (OS) and basic applications. For the “Mobile” type, a Blackberry communication device with corresponding remote access tools is also setup.

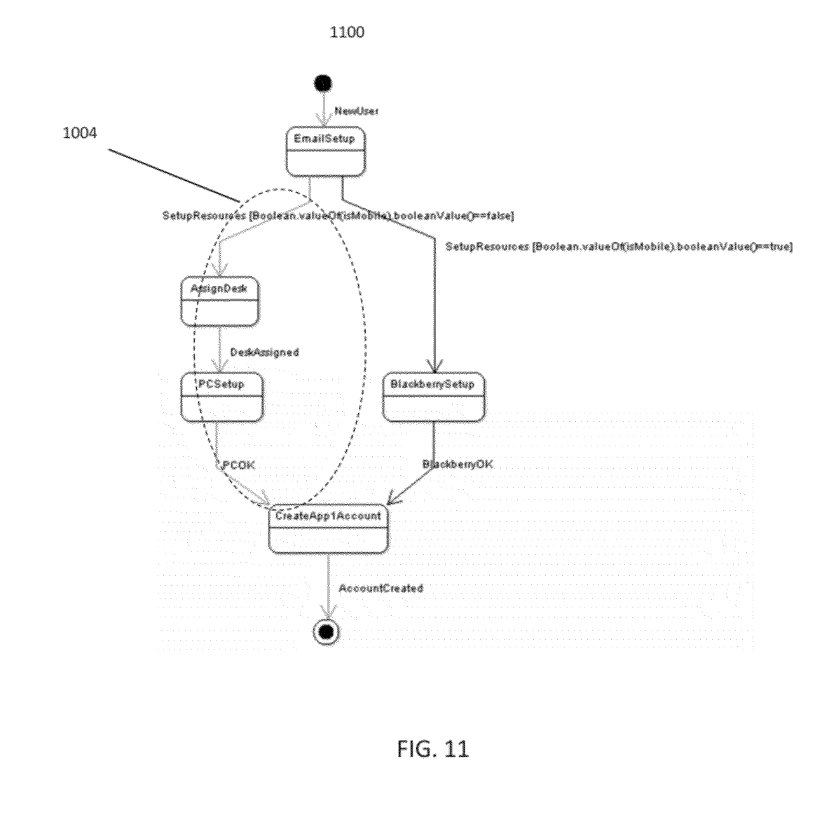

FIG. 11 is a flow chart of an exemplary illustration 1100 of setting up the new office user in accordance with the sequence of events 1004. The sequence of events 1004 depicts activities that are pushed when the new user selects an “Office” type computer system for access to the SCADA communications architecture 200. An exemplary sequence of events includes:
NewUser—startup event
SetupResources—the Boolean field “is Mobile” is false
DeskAssigned—event pushed after a desk was assigned
PCOK—event pushed after the corresponding PC was properly setup and installed
AccountCreated—event pushed after the account in the “Appl” was created.

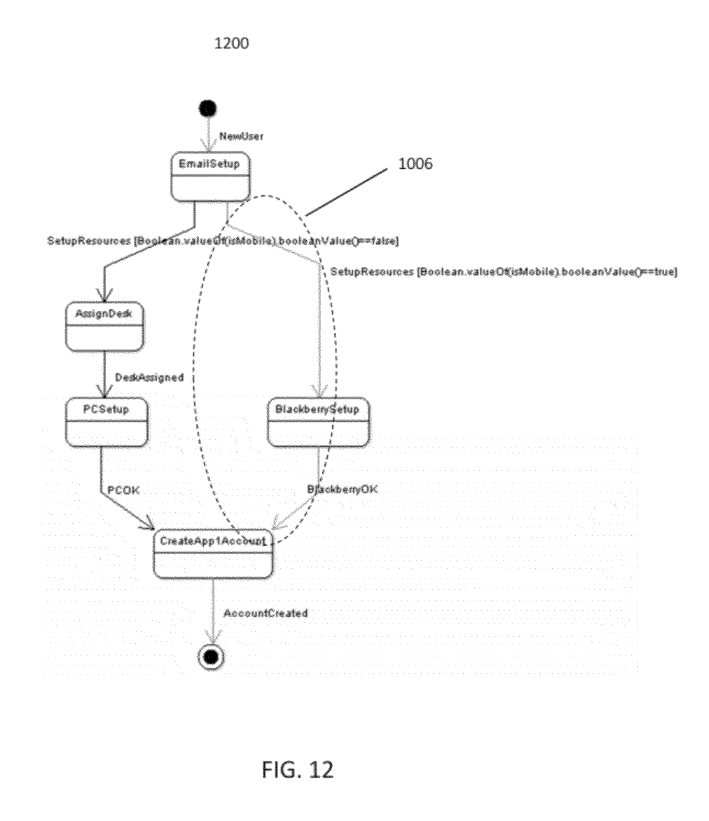

FIG. 12 is a flow chart of an exemplary illustration 1200 of setting up the new office user in accordance with the sequence of events 1006. The sequence of events 1006 depicts activities that are pushed when the new user selects a “Mobile” computer with access to the SCADA communications architecture 200. The sequence of events 1006 includes:
NewUser—startup event
SetupResources—the Boolean field “is Mobile” is true
BlackBerryOK—event pushed after the comm. Device was set up
AccountCreated—event pushed after the account in the “Appl” was created.

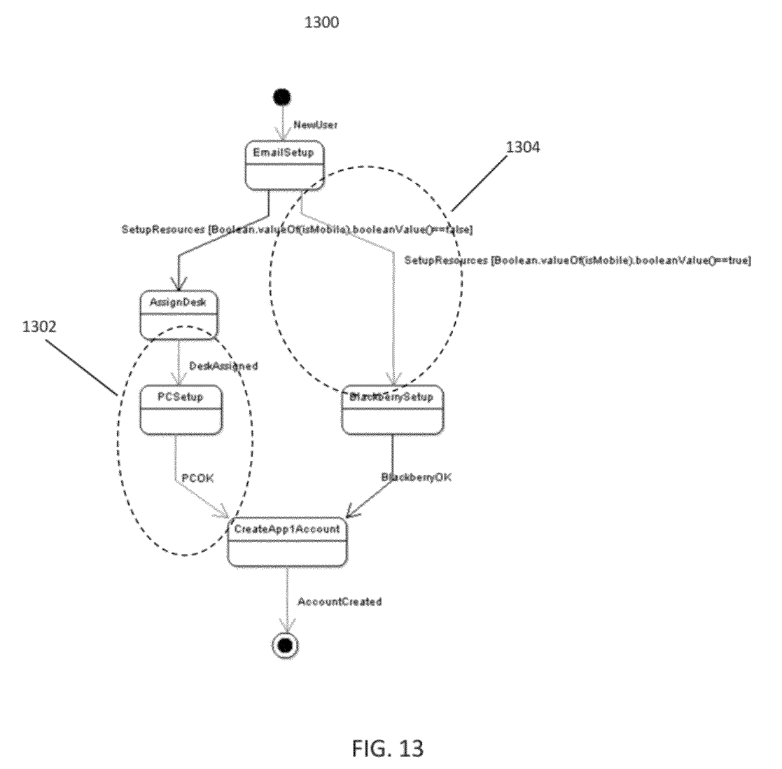

FIG. 13 is a flow chart of an exemplary illustration 1300 of a sequence of events pushed when the new user is set up as a “Mobile” type user. However, in the illustration, 1300 a sequence 1302, which includes a portion of the activities associated with an “Office” type user, is performed. Also, a sequence 1304 is performed. Sequence 1304 includes a portion of the activities related to setting up a mobile user. As per illustration 1300, the following events are pushed:
NewUser—startup event
SetupResources—the boolean field “is Mobile” is true
DeskAssigned—event pushed after a desk was assigned
PCOK—event pushed after the corresponding PC was properly setup and installed
AccountCreated—event pushed after the account in the “App l” was created.

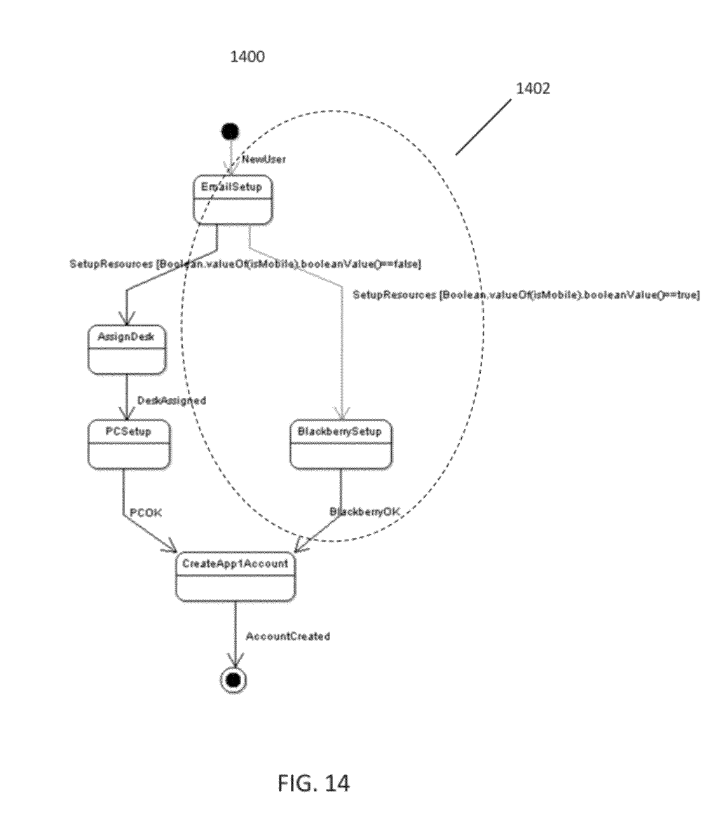

FIG. 14 is a flow chart of an exemplary illustration 1400 of a sequence of events 1402 that could trigger a process instance timeout in accordance with the embodiments. Such a timeout could be created by a Blackberry ok time out when the new user is added as a mobile user. The sequence 1402 includes

The following events are pushed:
NewUser—startup event
SetupResources—the boolean field “is Mobile” is true.

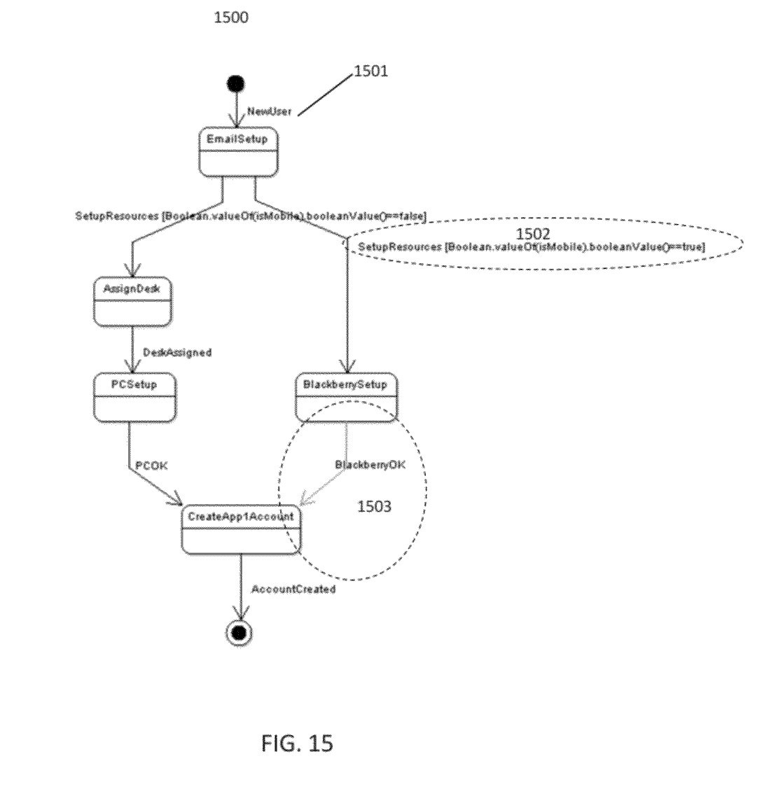

FIG. 15 is a flow chart of an exemplary illustration 1500 of an unauthorized alert in accordance with the embodiments. Without New User 1501 or Setup Resources invocation 1502; a Blackberry Ok event 1503 is invoked. This is caused by unauthorized access to the Blackberry inventory system. An unauthorized access will cause the anomaly security system 700 to generate an unauthorized alert.

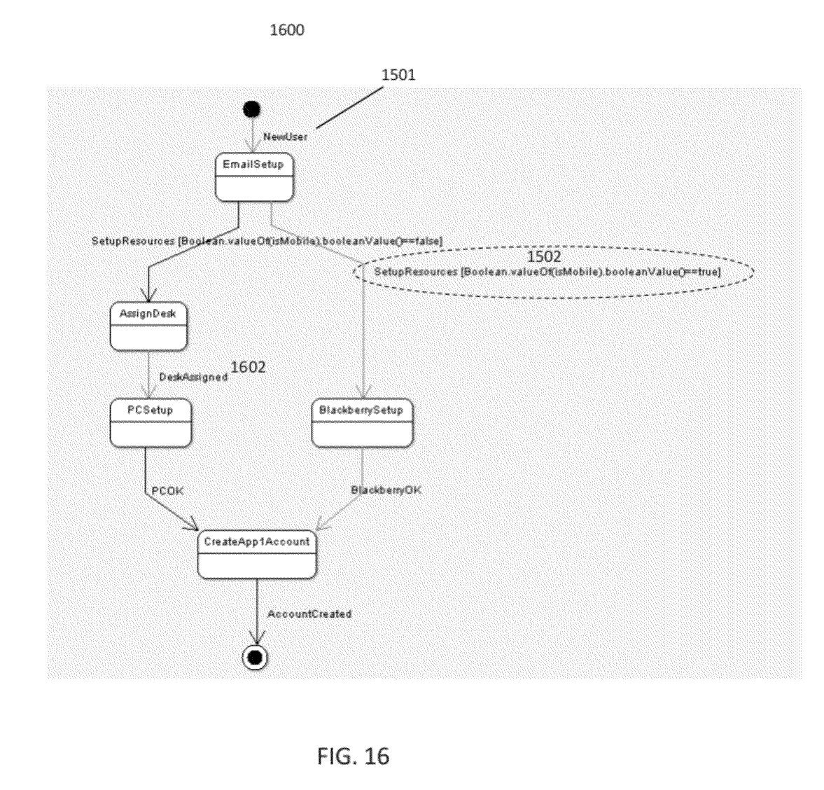

FIG. 16 is a flow chart of an exemplary illustration 1600 complex event processing fault detection in accordance with the embodiments.

public class PatternExec {

public PatternExec( ) {

pattern(((NewUser ( ) I> SetupResourcesForMobile ( )) II DeskAssigned ( ))) }
}

The above-deployed pattern in the anomaly security system 700 causes an alert when Events; New User 1501; Setup Resources For Mobile 1502; Desk Assigned 1602 are invoked.

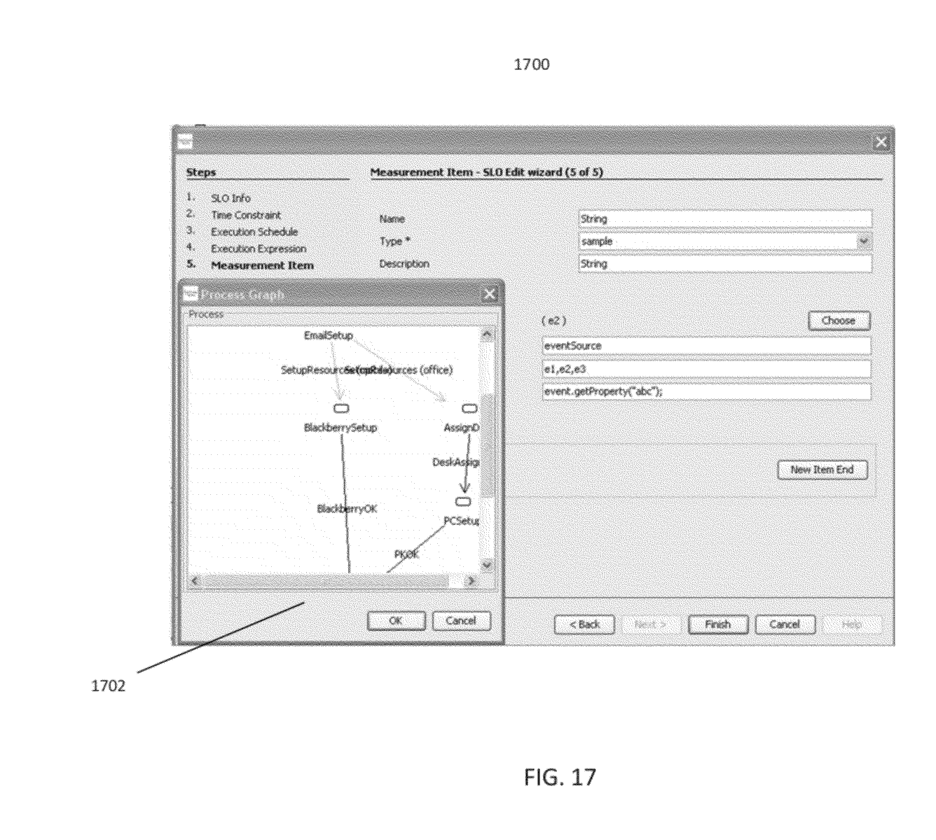

FIG. 17 is an illustration 1700 of exemplary service life cycle violation alerts in accordance with the embodiments. Using the deployed valid patterns expressions module 712; a valid event can be defined for every event in the process map 706. In the process instance; a measurement on each event is performed to ensure that the pre-defined event patter was not violated. If the event pattern was violated, the anomaly security system 700 generates an alert 1702.

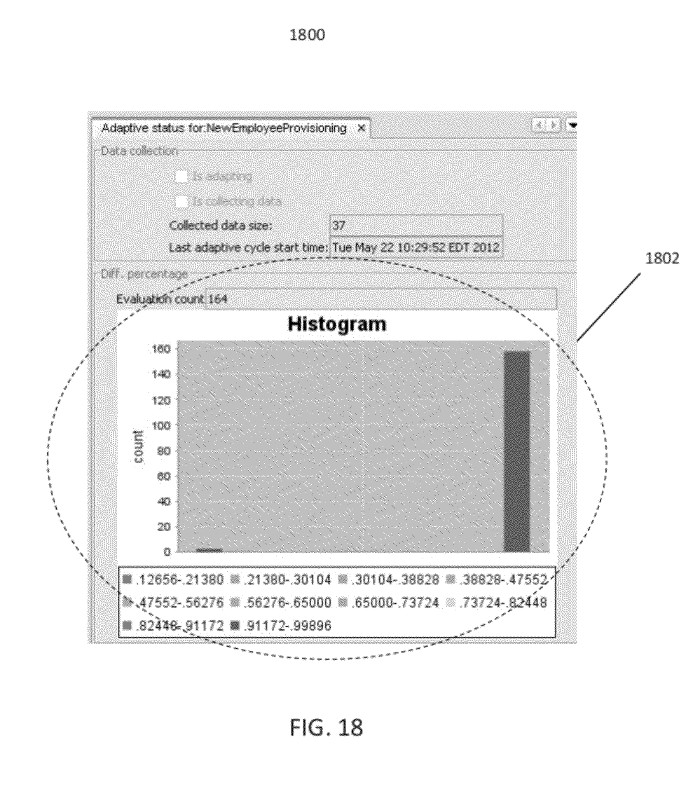

FIG. 18 is an illustration 1800 of an exemplary process instance trending in accordance with the embodiments. To ensure that process services are being used for correct purposes; an adaptive model 1802 is generated from the previous process instance records to test the current completed process instance. If the instance is outside the model, the anomaly security system 700 generates an alert.

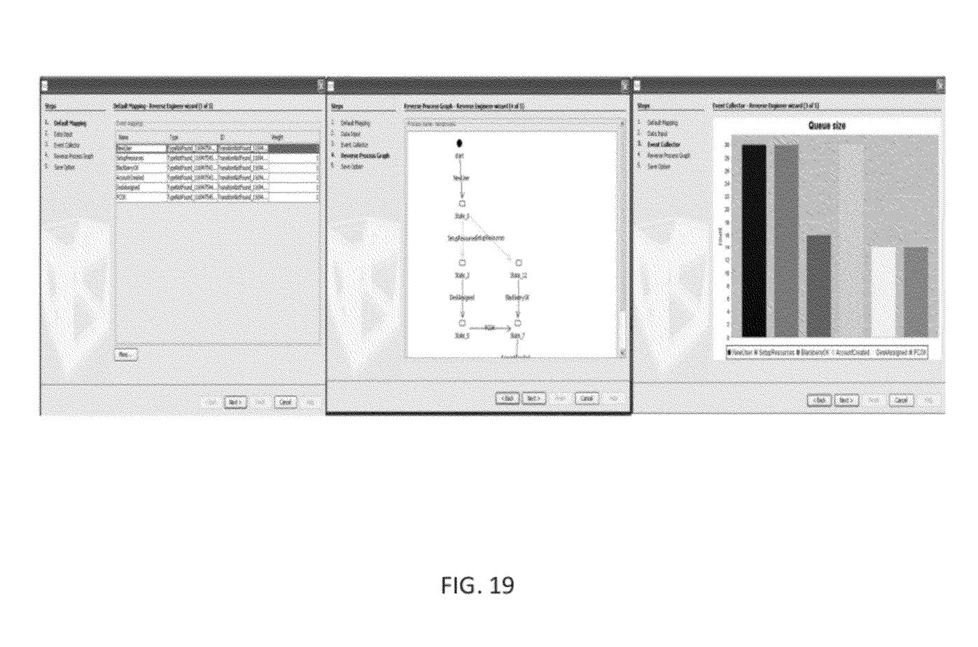

FIG. 19 is an illustration 1900 of an exemplary process discovery in accordance with the embodiments. When the anomaly security system 700 identifies anomalies at high rates, the enterprise desirably performs process discovery to identify any changes in the process. the anomaly security system 700 collect the events and aggregates for process map generation.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What we claim is:

1. A method of improving security in an electrical grid network, comprising:
configuring a lifecycle map associated with an operation in the electrical grid network, the lifecycle map including at least a start configuration, a final configuration, and a plurality of valid events arranged to link the start configuration and the final configuration, the start configuration and the final configuration corresponding to particular states of the electrical grid network;
monitoring at least one of messages and device configurations in the electrical grid network to detect one or more live events associated with the operation; and
comparing the plurality of live events to the lifecycle map to identify an anomaly in the live events.

2. The method of claim 1, further comprising:
reporting the anomaly; and
responsive to the reporting, changing configuration in at least one device to prevent an occurrence of a second operation in the electrical grid network.

3. The method of claim 1, wherein the comparing includes:
detecting the anomaly if either (1) the plurality of live events does not include a corresponding live event for each of the plurality of valid events occurring in a path in the lifecycle map from the first configuration to the final configuration, or (2) at least one of the live events does not have a corresponding one of the valid events.

4. The method of claim 3, wherein the detecting the anomaly comprises:
determining a first live event in the plurality of live events corresponding to a state transition to the final configuration; and
determining whether all of the valid events in a path from the start configuration to the final configuration have a corresponding event in the plurality of live events by traversing the lifecycle map in reverse from the final configuration.

5. The method of claim 1, wherein the monitoring comprises:
receiving live messages to or from a device in the electrical grid network; and
parsing the received live messages in real-time to detect one of the live events associated with the final configuration.

6. The method of claim 5, wherein the received live messages include messages generated corresponding to other messages in the electrical grid network or configuration changes in devices in the electrical grid network.

7. The method of claim 5, wherein the messages include messages to or from smart meters or smart power generators in the electrical grid network at end-user premises.

8. The method of claim 5, wherein the messages include messages to or from the device located in at least one of electricity distribution substations, electricity transmission substations, electricity generation plant or a control center for the electrical grid network.

9. A system for improving security and resiliency of an electrical grid network, comprising:
a processor;
a memory coupled to the processor;
a process lifecycle map creator configured to be executed by the processor and further configured to configure, in the memory, a lifecycle map associated with an operation in the electrical grid network, wherein the lifecycle map includes at least a start configuration, a final configuration, and a plurality of valid events arranged to directly or indirectly link the start configuration and the final configuration, wherein the start configuration and the final configuration correspond to particular states of the electrical grid network;
an event monitor configured to be executed by the processor and further configured to monitor at least one of messages and device configurations in the electrical grid network to detect a plurality of live events associated with the operation;
an event comparing module configured to be executed by the processor and further configured to compare the plurality of live events to the lifecycle map to identify an anomaly in the plurality of live events; and
an alerting module configured to be executed by the processor and further configured to report, based upon the comparing, the anomaly associated with the operation.

10. The system of claim 9, further comprising:
a configuration module configured to be executed by the processor and further configured to, responsive to the reporting, change configuration in at least one device to prevent an occurrence of a second operation in the electrical grid network.

11. The system of claim 9, wherein the event comparing module is further configured to:
detect the anomaly if either (1) the plurality of live events does not include a corresponding live event for each of the plurality of valid events occurring in a path in the lifecycle map from the first configuration to the final configuration, or (2) at least one of the live events does not have a corresponding one of the valid events.

12. The system of claim 11, wherein the detecting the anomaly comprises:
determining a first live event in the plurality of live events corresponding to a state transition to the final configuration; and
determining whether all of the valid events in a path from the start configuration to the final configuration have a corresponding event in the plurality of live events by traversing the lifecycle map in reverse from the final configuration.

13. The system of claim 9, wherein the event monitor is further configured to:
receive live messages to or from a device in the electrical grid network; and
parse the received live messages in real-time to detect one of the live events associated with the final configuration.

14. The system of claim 13, wherein the received live messages include messages generated corresponding to other messages in the electrical grid network or configuration changes in devices in the electrical grid network.

15. The system of claim 13, wherein the messages include messages to or from smart meters or smart power generators in the electrical grid network at end-user premises.

16. The system of claim 13, wherein the messages include messages to or from the device located in at least one of electricity distribution substations, electricity transmission substations, electricity generation plant or a control center for the electrical grid network.

17. A computer readable storage medium storing instructions thereon, the instructions, when executed by a processor, are configure to perform a method comprising:
configuring a lifecycle map associated with an operation in the electrical grid network, wherein the lifecycle map includes at least a start configuration, a final configuration, and a plurality of valid events arranged to directly or indirectly link the start configuration and the final configuration, wherein the start configuration and the final configuration correspond to particular states of the electrical grid network;
monitoring at least one of messages and device configurations in the electrical grid network to detect a plurality of live events associated with the operation; and
comparing the plurality of live events to the lifecycle map to identify an anomaly in the plurality of live events.

18. The computer readable storage medium of claim 17, further comprising reporting the anomaly.

19. The computer readable storage medium of claim 18, further comprising responsive to the reporting, changing configuration in at least one device to prevent an occurrence of a second operation in the electrical grid network.

20. The computer readable storage medium of claim 19, wherein the monitoring comprises:
receiving live messages to or from a device in the electrical grid network; and
parsing the received live messages in real-time to detect one of the live events associated with the final configuration.
